(19) United States
(12) Patent Application Publication
(10) Pub. No.: US 2025/0221871 A1
(43) Pub. Date: Jul. 10, 2025

(54) SYSTEM FOR DETECTING AN OBJECT OR ACCESSORY ON MEDICAL TABLES

(71) Applicant: MAQUET GMBH, Rastatt (DE)

(72) Inventors: Tim GOLDE, Weingarten (DE); Rodrigo DEL ALCAZAR VON BUCHWALD, Waldbronn (DE)

(21) Appl. No.: 18/854,927

(22) PCT Filed: Apr. 6, 2023
(86) PCT No.: PCT/EP2023/059146

§ 371 Date: Oct. 7, 2024

(30) Foreign Application Priority Data
Apr. 8, 2022 (DE) 10 2022 108 635.6

(51) Int. Cl. A61G 13/02

(52) U.S. Cl. CPC A61G 13/02

(57) ABSTRACT

A system for detecting an object or accessory placed on or attached to a patient positioning device or moved on or removed therefrom, the system comprising: a surgical patient positioning device which can be used as part of an operating table; a load sensor array with at least one load sensor that outputs sensor values; a load determination unit that determines a load and/or a center of gravity of the load based on the sensor values, the load comprising a load acting on the load sensor array or a load acting on the patient positioning device; and a detection unit that receives the load and/or the center of gravity determined by the load determination unit and which, when an object or accessory is placed on or attached to the patient positioning device or moved on or removed therefrom and the load and/or the center of gravity determined by the load determination unit change as a result, determines the weight and/or the center of gravity of the object or accessory therefrom.

The present application claims priority from German patent application no. 10 2022 108 635.6, which was filed with the German Patent and Trademark Office on Apr. 8, 2022. The disclosure of German patent application no. 10 2022 108 635.6 is hereby incorporated into the disclosure of the present application.

### TECHNICAL FIELD

The present disclosure relates to medical and surgical tables that can be expanded with accessories. In particular, it concerns systems that can detect and identify accessories and objects that are attached to or removed from medical tables.

### BACKGROUND OF THE DISCLOSURE

Operating tables are used to position a patient, for example during a medical or surgical procedure. Operating tables can be expanded with accessories in order to ensure optimal positioning of the patient and to carry out the procedure reliably. Accessories can be detachably attached to an operating table for various purposes. For example, they can be used to position certain parts of the body, such as the head, a leg, or an arm. However, accessories can also have other functions; for example, accessories can be instrument tables or infusion holders that are attached to the side rails of the operating table.

Through the use of various interchangeable accessories, a single operating table can be reconfigured in different ways for different patients and medical procedures. However, this means that the size, shape, dimensions, weight, and strength of each operating table vary at different times. In order to prevent the operating table from tipping over or individual structural parts or the entire operating table from being overloaded, it is important to know which accessories are attached to an operating table and where on the operating table these accessories are located. Only when the configuration of the operating table is known can the limitations of the operating table be specified with certainty.

Once the accessories of an operating table have been identified, information about individual accessories can be displayed to a user of the operating table, for example on a display.

Hospitals often have a variety of accessories that can be connected to different operating tables. In order to ensure a smooth workflow and enable possible planning conflicts to be identified and addressed, it is important to know where the individual accessories can be found in the hospital and to which operating tables the individual accessories are attached.

Tracking and management of supplies in a hospital is often performed manually or using barcodes, making it difficult to locate lost supplies.

For certain operations, operating tables should be equipped with certain accessories in order to be able to carry out the desired procedure. It would be desirable to simplify the preparation of an operating table for an operation and to eliminate possible sources of error.

Document WO 2018222564 A1 discloses a patient positioning system with a platform for positioning a patient. The platform may comprise various removable attachments for supporting the patient from below, such as leg attachments, head attachments, lower body attachments, back attachments, and the like. The attachments are installed at the head or foot end of the platform, for example using a pin or a plug/socket connection. RFID technology can be used at the interfaces between the platform and the removable attachments. The RFID labels and readers can facilitate identification and communication between the holders and the operating table. WO 2018222564 A1 does not disclose a system as disclosed herein which detects a change in load and/or center of gravity caused by the attaching of attachments and can determine the weight and/or center of gravity of the attachment on that basis. Furthermore, the combination of proximity sensors with the measurement of changes in weight and center of gravity when adding attachments to the operating table is not taught. In WO 2018222564 A1, only attachments that are connected directly next to an RFID reader on the operating table can be recognized. Attachments at other locations cannot be detected. In addition, only attachments that extend the platform at the ends of the table are able to be recognized. Detection of attachments that are attached to a side rail is not possible.

### SUMMARY OF THE DISCLOSURE

It is an object of the present disclosure to provide a system which is advantageously designed to detect and, in particular, to identify an object or an accessory that is placed on or attached to a patient positioning device or that has been moved on or removed from the patient positioning device.

Another object of the present invention is to determine the weight and/or center of gravity of the object or accessory.

According to a first aspect of the present disclosure, a system is provided which serves to detect and, in particular, identify an accessory or an object which has been placed on or attached to a patient positioning device or which has been moved or shifted on or removed from the patient positioning device. The system may comprise a surgical patient positioning device, a load sensor array with at least one load sensor, one load determination unit, and one detection unit.

The patient positioning device can be used as part of an operating table and can be used to position a patient, for example during a surgical procedure. Furthermore, the patient positioning device can be used to attach accessories. The patient positioning device can have a modular design and include a main positioning surface section that can be expanded by connecting various secondary positioning surface sections. The secondary positioning surface sections can be considered accessories. The main positioning surface section and the secondary positioning surface sections can have mechanical connecting elements with which the main and secondary positioning surface sections can be detachably connected. Secondary positioning surfaces can be leg, foot, or head sections, for example. Furthermore, secondary positioning surface sections can also be extension or intermediate sections which are inserted, for example, between the main positioning surface section and the head section.

In some embodiments, the patient positioning device can be non-detachably connected to a column of an operating table. The operating table can be movable. A base of the operating table can have wheels or castors which enable the operating table to be moved on the floor. Alternatively, the base can be permanently anchored to the floor.

In some embodiments, the patient positioning device may be designed to be detachably connected to a movable surgical patient transporter and a column of an operating table. Before a surgical procedure, the patient positioning device can be mounted on the patient transporter. The patient can be brought to the operating table using the patient transporter. There, the patient positioning device can be attached to the operating table column and decoupled from the patient transporter. Much of the preparation for surgery can be carried out while the patient positioning device is mounted on the patient transporter. For example, the patient positioning device can be assembled from individual segments and accessories, and the patient can be prepared for the surgical procedure. Only when the preparations are complete can the patient positioning device be attached to the operating table column.

The load sensor array may comprise one or more load sensors. A single load sensor may be sufficient if only the load is to be determined. Alternatively or in addition, if the center of gravity of the load is to be determined, the load sensor array can contain a plurality of load sensors, for example two, two or more, three, three or more, or four load sensors, or even additional load sensors. If a 6D force sensor is used, the center of gravity can also be calculated using a single sensor. The at least one load sensor can output sensor values from which a load acting on the load sensor array and also a load acting on the patient positioning device can be determined. The load acting on the load sensor array can, in particular, include all external force quantities, i.e., forces and moments, which act on the load sensor array.

The load sensors can be force sensors, for example, in particular load cells, each of which measures a force acting on the respective sensor. The force sensors can each output an electrical signal, for example an electrical voltage, from which the measured force can be derived. Furthermore, a provision can also be made that the force sensors each output the concrete magnitude of the force measured by them as a sensor value, for example in digital form.

It is also conceivable for the load sensor array to determine a resulting total force from the sensor values of a plurality of load sensors, in which case the resulting total force results from the individual forces acting on the different force sensors.

The load acting on the load sensor array includes, for example, the load exerted by the components of the operating table that are arranged above the load sensor array as well as the load exerted by the patient supported on the patient positioning device or other objects located on the patient positioning device. Furthermore, a person can also exert a load on the patient positioning device, for example by standing next to the operating table and supporting themselves on the patient positioning device with a hand or another part of the body. In addition, external forces generated in other ways can exert a load on the patient positioning device. Such loads can also be measured by the load sensor array.

In some embodiments, the load sensor array may be arranged at different positions in the operating table. For example, the load sensor array can be integrated into the column of the operating table or into the patient positioning device. Furthermore, the load sensor array can be arranged at or adjacent to interfaces which the column forms with the patient positioning device or the stand (or base). The load sensor array can thus be arranged, for example, between the patient positioning device and the column. Alternatively, the load sensor array can be arranged, for example, between the column and the base.

In some embodiments, the load sensor array can be integrated into the patient transporter.

The load sensor array can be integrated into the operating table or the patient transporter in such a way that the complete load flows or is transmitted through the load sensor array. In particular, the load that is exerted above the load sensor array can flow through or be transmitted through the load sensor array.

The load determination unit can be coupled to the load sensor array and receive the sensor values outputted by the one or more load sensors. Based on the sensor values, the load determination unit can determine a load and/or a center of gravity of the load in a given coordinate system. In other words, the load determination unit determines either only the load or only the center of gravity of the load or both the load and the center of gravity of the load. The load may include a load acting on the load sensor array or a load acting on the patient positioning device. In some embodiments, the load determined by the load determination unit may be a load acting on the load sensor array or a load acting on the patient positioning device or a total load of the operating table or a total load of the patient transporter on which the patient positioning device is mounted. The center of gravity of the load can be specified relative to a defined point on the patient positioning device or operating table. Furthermore, the center of gravity of the load can also be specified in a coordinate system that may not be related to the patient positioning device or the operating table but whose origin is fixed at an external point, for example at a defined point in the operating room. This enables the absolute position of the center of gravity of the load to be specified.

The load acting on the load sensor array can also be referred to as the measuring load. The measuring load corresponds to the load generated by all persons, objects, and forces on the operating table or patient transporter above the load sensors. The measuring load corresponds to the load value measured by the load sensor array.

The load acting on the patient positioning device can be referred to as the effective load and corresponds to the load exerted by components not associated with the patient positioning device or the operating table or the patient transporter, and persons and external forces acting on the patient positioning device. Components associated with the patient positioning device can be components that are detected by a detection system, such as positioning surface sections or segments and/or other accessories. The influence of components associated with the patient positioning device or the operating table or the patient transporter is not taken into account in the effective load. Only the remaining components contribute to the effective load, i.e., the components not associated with the patient positioning device or the operating table or the patient transporter. These may be, for example, accessories that are not recognized by the detection system or other objects that are placed on the patient positioning device. Furthermore, the patient lying on the patient positioning device contributes to the effective load. The effective load also includes any and all external forces acting on the patient positioning device, for example forces exerted on the patient positioning device by persons and/or objects outside the patient positioning device.

If the patient positioning device is mounted on the column of the operating table or the patient transporter, the total load of the operating table or the patient transporter can also be determined. The total load of the operating table or patient transporter is the load resulting from the measuring load and from a load exerted by components that are associated with the operating table or patient transporter and are located below the load sensor array. The total load therefore takes into account loads from components that are located below the load sensor array and cannot be measured by the load sensor array and therefore do not contribute to the measuring load. The total load is therefore the load resulting from the entire operating table or patient transporter, the patient, the components associated with the operating table or patient transporter, the components not associated with the operating table or patient transporter, and other external forces.

The detection unit can be coupled to the load determination unit and can receive the quantities determined by the load determination unit, i.e., the load and/or the center of gravity of the load. When an object or accessory is placed on or attached to the patient positioning device or moved on or removed from the patient positioning device, the load and/or the determined center of gravity of the load determined by the load determination unit will change. The movement of an object or accessory on the patient support means that the object or accessory is already on the patient support and has been moved, i.e., the position thereof on the patient support has changed. The detection unit can be designed such that it determines the weight and/or the center of gravity of the corresponding object or accessory from a change in the load and/or in the center of gravity of the load. The center of gravity determined by the detection unit may be the center of gravity of the object or accessory at the time it is located on or attached to the patient positioning device. If the object or accessory is moved or shifted on the patient positioning device, the detection unit can determine the center of gravity of the object or accessory before and/or after the movement or shift. In particular, the measuring load, effective load, and/or total load can remain constant when an object or accessory is moved or shifted on the patient positioning device. Consequently, if the object or accessory is removed from the patient positioning device, the center of gravity determined by the detection unit is the center of gravity that the object or accessory had before it was removed from the patient positioning device.

The detection unit enables an object or accessory attached to the patient positioning device added to, moved onto, or removed from the object and to determine the weight and center of gravity thereof. Such information can be used to determine which accessories are compatible with the patient positioning device, i.e., which configuration the patient positioning device is currently in. This can be done automatically; there is no need to enter the configuration manually into an input unit in order to appropriately inform the system. Only if the configuration of the patient positioning device is known can the limits of the operating table or patient transporter be reliably specified in order to prevent tipping-over of the operating table or patient transporter or overloading of individual structural parts or of the entire operating table or patient transporter.

Furthermore, a user can be provided with information about the recognized configuration of the patient positioning device. For example, the configuration can be shown to the user on a display. In addition, information about individual accessories can be shown on the display.

Furthermore, information about which objects and accessories are attached to the patient positioning device and which have been removed can be stored in a central database. In hospitals, this makes it easier to track and manage accessories, especially when the objects and accessories are used on multiple operating tables. The central database provides information about where each object and accessory is located. In particular, the central database shows which objects and accessories are attached to the various patient positioning devices and operating tables and which objects and accessories are not in use and are being stored in a storage room, for example.

Data on the use of individual objects and accessories can also be stored in a hospital's central database. For example, it can be documented when and/or during which operation the respective objects and accessories were used. Such documentation can help to ensure proper maintenance of the objects and accessories. It can also be determined whether certain objects and accessories should be purchased because these objects and accessories are not available in sufficient quantities.

Furthermore, a central database facilitates the planning of operations. With the aid of the central database, for example, the existing objects and accessories can be reserved for planned operations, thus ensuring that the required objects and accessories are available for the planned operations. Furthermore, such a reservation system can also detect whether certain objects and accessories are not available in sufficient quantities in order to carry out the desired operations.

Furthermore, a register or catalogue can be created in which the respective configuration of the operating table is noted for each type of operation, i.e., which objects and accessories are required for a specific operation. For example, the operating table may be configured differently for an operation on a patient's arm than for an operation on their hip. In addition, the register may also contain specifications for individual surgeons who perform the procedures. Each surgeon may have individual wishes regarding the configuration of the operating table. For example, an operating table may be set up differently for a left-handed surgeon than for a right-handed surgeon.

The system described herein can assist a user in assembling a desired operating table configuration. For example, the system can access the register and use the detection unit to determine which objects or accessories have been added to or removed from the patient positioning device. For example, a user tasked with assembling the operating table in the desired configuration can be informed on a display as to which objects and/or accessories still need to be attached to or removed from the patient positioning device. Furthermore, the user can also be alerted if an object or accessory is attached to the operating table in the wrong place. Once an operating table is equipped with all necessary objects and accessories, the user can be informed that the operating table is ready for the intended operation.

The load determination unit and/or the detection unit can either be integrated into the operating table or the patient transporter, or it can be located outside the operating table or patient transporter. For example, the load determination unit and/or the detection unit can be integrated into a computing unit that is located outside the operating table or the patient transporter and is connected to the operating table or patient transporter, for example via radio or fixed cabling.

As described above, the patient positioning device have a modular design and have a main positioning surface section that can be extended by connecting various secondary positioning surface sections or other accessories. Each secondary positioning surface section can be an intermediate or an end section. An intermediate section can have interfaces on two sides for connection to the main positioning surface section, to another secondary positioning surface section, or to another accessory. Connecting elements for detachable mechanical connection to the main positioning surface section or another accessory part can be provided at the interfaces. An end section can have a connecting element on only one side for detachable mechanical connection to the main positioning surface section or another accessory part, in particular to an intermediate section. The patient positioning device can have a head end and a foot end. In some embodiments, the head and foot ends may be variable depending on the type and position of the extensions and may be automatically determined as a function of which extensions are added on different sides of the main positioning surface section. For example, based on where headrest and legrest sections are added and detected.

The mechanical connecting elements can create a strong and resilient connection between the positioning surface sections and accessories.

In some embodiments, the connecting elements can be embodied as male or female plug-in assemblies, the male assemblies attached to one positioning surface section being able to be plugged into complementary receiving openings of the female assemblies on another positioning surface section or accessory. The male assemblies may, for example, be pins, studs, or plug assemblies, and the female assemblies may have a complementary configuration, for example a socket assembly, a concave space, or an empty interior space. Alternatively, hooking, clamping, or locking connections can be used.

Locking elements which are arranged particularly in the male assemblies can be moved between a release position and a locking position and secure the mechanical connection between two segments against unintentional separation.

In some embodiments, exactly two male assemblies and exactly two complementary female assemblies can be provided for the connection between two positioning surface sections or accessories, the two male assemblies being attached to one positioning surface section/accessory and the two female assemblies being arranged on the other positioning surface section/accessory. A different number of male and female assemblies for establishing the connection between two positioning surface sections or accessories is also conceivable.

The accessories that can be attached to the patient positioning device by means of the connecting elements described above constitute a group of accessories. Another group of accessories can be detachably connected to one of the side rails, also called sliding rails, which can be attached to either side of the patient positioning device. The side rails can also be attached to the head and foot ends. For example, head and/or leg plates can also be equipped with side/sliding rails at the ends.

Another group of accessories can be attached to the patient positioning device using adapters. The adapters, in turn, can be connected to the connecting elements or to the slide rails.

Furthermore, there is a group of accessories that are not permanently connected to the patient positioning device but can only be placed or stored on it. For example, gel cushions on which the patient's head or other body part can be rested belong to this group of accessories.

Accessories that are used to position the body, for example the back, head, arms, feet, or legs, have already been described. Accessories can also be used for a variety of other purposes. Below are some examples of accessories:
anaesthetic hangers for holding surgical drapes,
tube holders for securing a ventilation tube,
side protection walls to secure the patient during transport on the patient positioning device,
infusion holders,
flushing sets for collecting and draining liquids,
catheter racks for storing catheters during surgery,
instrument tables for storing instruments during surgery,
trays for dirty instruments,
disposal trays for collecting surgical waste,
push handles for moving operating tables,
devices for controlling the flow of liquids, and
adjustable arm or hand supports for positioning the arms or hands during surgery which can be attached to the side rails.

The system described herein can detect objects other than accessories when the objects are placed or placed on the patient positioning device. There are a variety of different objects that the system can detect. Some examples of the objects are listed below:
urine collection bag and the corresponding scale,
infusion and saline solutions which can, in particular, be suspended from an infusion holder,
infusion pumps,
surgical drapes which can be hung on an anesthesia hanger or other supports,
assistive devices such as lung assist devices,
instruments that can be stored particularly on an instrument table,
dirty instruments, which can be placed in a tray for dirty instruments,
X-ray cassettes that can be pushed under the patient and the patient positioning device on some operating tables, and
radiation shielding curtains.

In some embodiments, the load determining unit may determine the load and/or the center of gravity of the load before and after an object or accessory is placed on or attached to the patient positioning device or moved on or removed therefrom. The detection unit may compare the loads and/or the centers of gravity of the loads determined by the load determination unit before and after the object or accessory was placed on or attached to the patient positioning device or moved on or removed therefrom. By comparing both states, the detection unit can determine the weight and/or center of gravity of the object or accessory.

In some embodiments, the system may include a first storage unit in which weight information about predetermined objects and/or accessories is stored. The detection unit can access the first storage unit and compare the weight of the object or accessory determined by it with the weight information stored in the first storage unit. By comparing the weights, the detection unit can determine which at least one object or accessory may have been placed on or attached to the operating table or moved on or removed therefrom. If two or more accessories or objects have the same or a similar weight, the detection unit cannot distinguish between these accessories and objects if only the weight is used to detect the accessories and objects. In that case, all accessories or objects stored in the first storage unit that have the same or similar weight are possible candidates for detection by the detection unit.

In some embodiments, at least a part of the patient positioning device and, in particular, at least a part of the environment of the patient positioning device can be virtually divided into multiple regions. For example, the patient positioning device and the immediate surroundings thereof can be divided into one or two side regions, a foot region, and a head region and, if necessary, other regions. A second storage unit of the system can store region information that indicates the regions in which specified objects and/or accessories are located. For example, a head plate can be associated with the head region and an arm support with the side region(s). Because the detection unit knows the center of gravity of the object or accessory that is added or removed, the detection unit can compare the center of gravity with the range information and use the comparison to determine which one or more objects or accessories may have been placed on or attached to the patient positioning device or moved on or removed from the patient positioning device.

Comparing the center of gravity with the data stored in the second storage unit can further improve the detection of the object or accessory being sought. For example, if two or more possible candidates were identified when comparing the weight determined by the detection unit with the weight information stored in the first storage unit, one or more of these candidates may be excluded by comparing the center of gravity with the data stored in the second storage unit, since these objects or accessories are not associated with the region detected by the detection unit.

If the system has both the first and the second storage unit, the two storage units can be embodied as a common storage unit.

In some embodiments, at least some of the objects and/or accessories may each have a proximity tag, also called a proximity sensor. The proximity tags emit a respective identification code. The identification code of each proximity tag can be unique, so that the identification code can be used to precisely identify the respective object and/or accessory. Furthermore, the system can have a reading unit which receives the identification codes emitted by the proximity tags. This enables the detection unit to determine exactly which objects or accessories are in the vicinity of the patient positioning device based on the identification codes received from the reading unit. In addition to the weight and/or the center of gravity of the load determined by the detection unit, the received identification code can be used as a further criterion to determine which object or accessory has been attached to or removed from the patient positioning device. The reading unit can be integrated into the patient positioning device or operating table or patient transporter. In some embodiments, the reader is capable of detecting proximity tags from objects and accessories that are not in close proximity to the reader. For example, the reading unit may be able to identify proximity tags that are located at a distance of at least 0.5 m or at least 1 m from the reading unit.

In some embodiments, it is possible for not all objects and accessories to be equipped with a respective proximity tag, but rather only a portion of the objects and accessories. A provision can also be made that none of the objects has a proximity tag. Furthermore, it is conceivable for all accessories to be equipped with a proximity tag.

There are many known technologies that can be used for proximity tags. For example, the proximity tags and the reading unit can be designed with one of the following technologies:
passive RFID (radio-frequency identification) proximity tags on the objects and/or accessories and an active RFID scanner built into the operating table as a reading unit,
active (battery-operated) ultrasonic proximity tags on the objects and/or accessories and an ultrasonic microphone built into the operating table as a reading unit,
active (battery-operated) Wi-Fi proximity tags on the objects and/or accessories and a Wi-Fi receiver built into the operating table as a reading unit,
active (battery-operated) infrared transmitters on the objects and/or accessories and an infrared receiver built into the operating table as a reading unit, and
active (battery-powered) Bluetooth low-energy proximity tags on the objects and/or accessories and a Bluetooth scanner module built into the operating table as a reading unit.

In the system described herein, the transmission of the identification codes from the proximity tags to the reading unit is preferably based on the Bluetooth standard.

The proximity tag frequently emits a periodic signal that can be read by the reader. The fact that the reader receives the signal indicates that the object or accessory is at least within the range of the signal.

In addition, the actual strength of the observed signal can be used to estimate the distance between the patient positioning device and the proximity tag. In some embodiments, the detection unit can determine whether the corresponding object or accessory is located in the vicinity of the patient positioning device based on the signal strength with which the reading unit receives the identification code.

Furthermore, a threshold value for the signal strength can be specified. If the signal strength received by the reading unit exceeds the threshold, the detection unit can determine that the corresponding object or accessory is in the vicinity of the patient positioning device.

In some embodiments, various conditions or criteria are used to determine whether an object or accessory has been placed on, attached to, moved on, or removed from the patient positioning device. According to a first condition, the detection unit determines that the corresponding object or accessory is in the vicinity of the patient positioning device, for example based on the reading unit receiving the identification code of the corresponding proximity tag. According to a second condition, it is necessary that the weight of the corresponding object or accessory determined by the detection unit lie within a predetermined range around the weight information stored in the first storage unit for this object or accessory. The specified range can be selected to compensate for any measurement inaccuracies. According to a third condition, the center of gravity of the corresponding object or accessory determined by the detection unit should lie within a range provided for this object or accessory and stored in the second storage unit.

The first to third conditions can be combined in any way. For example, the detection unit can be designed to use only two of the three conditions, i.e., either the first and second condition or the first and third condition or the second and third condition. However, the detection unit can also be designed to employ all three conditions. Only if the selected conditions are met can it be detected that an object or accessory has been placed on, attached to, moved on, or removed from the patient positioning device.

A further, fourth condition may be to examine the movement of an object or accessory. Only if an object or accessory is moving or has recently moved can it have been added to or removed from the patient positioning device. In some embodiments, at least some of the objects and/or accessories may each have a motion detector that detects movement of the respective object or accessory. Information about the movement state of the object or accessory can be transmitted to the detection unit, which can then use this information to detect the object or accessory.

In some embodiments, the motion sensor can transmit information about the motion state of the respective object or accessory to the proximity tag, and the proximity tag can transmit this information, which can then be received by the reading unit and forwarded to the detection unit.

In some embodiments, the motion detector and/or the detection unit may have a memory function that stores the movements of the respective object or accessory for a predetermined period of time. This is advantageous because not only one point in time is considered, but rather it can be examined over the specified period of time in order to determine whether the object or accessory has moved. The specified time period can be selected so as to allow for reliable detection of the object or accessory. The specified time period can be a few seconds, for example 5 or 10 seconds, or any other suitable time period.

In some embodiments, the detection unit can determine that an object or accessory has been placed on or attached to the patient positioning device or moved on or removed therefrom if the detection unit receives from the reading unit the identification code of the corresponding object or accessory and, additionally, the information that the corresponding object or accessory has moved or has recently moved, and the load determination unit also determines that the load and/or the center of gravity of the load have changed.

The above system may be refined by one or more conditions that must be met in order for the detection unit to determine that an object or accessory has been placed on or attached to the operating table or moved on or removed therefrom. In some embodiments, the condition may be added that the weight of the corresponding object or accessory determined by the detection unit is within the predetermined range around the weight information stored in the first storage unit for this object or accessory.

In some embodiments, in addition to or as an alternative to the aforementioned condition, the condition can be set that the center of gravity of the corresponding object or accessory determined by the detection unit lie within a region provided for this object or accessory and stored in the second storage unit.

When not needed, operating tables as well as patient transporters and associated patient positioning devices or parts thereof can often be switched from an active mode to a ready mode, also called standby mode, in order to save energy. In some embodiments, the load and/or the determined center of gravity of the load determined by the load determination unit can be stored before switching to the standby mode. Immediately after returning from standby mode to active mode, the load determination unit can redetermine the load and/or the center of gravity of the load. The detection unit can compare the determined loads and/or centers of gravity of the loads before and after operation in standby mode. Based on the comparison (if only the loads or only the centers of gravity of the loads were compared) or the comparisons (if both the loads and the centers of gravity of the loads were compared), the detection unit can determine whether an object or accessory was placed on or attached to the patient positioning device, or moved on or removed therefrom while the operating table or patient transporter was being employed in standby mode.

In some embodiments, the patient positioning device may include a touch and/or motion sensor array that can detect a contact with and/or movement of the patient positioning device. The touch and/or motion sensor array can also be designed such that it can detect a touch and/or movement not only of the patient positioning device, but of the entire operating table or patient transporter. If a contact with and/or movement of the patient positioning device or operating table or patient transporter is detected during standby mode, the touch and/or motion sensor array may cause the patient positioning device or the operating table or patient transporter to return to the active mode. The touch and/or motion sensor array may, for example, include a capacitive sensor and/or an accelerometer. The load sensors can also be used to detect contact and/or movement of the patient positioning device. The touch and/or motion sensor array can be in communication with the load sensors. If a force is detected on one or more load sensors during standby mode, this is communicated to the touch and/or motion sensor array so that it can initiate a return to active mode.

If at least some of the objects and/or accessories also have a motion detector with a memory function that stores the movements of the respective object or accessory for a specified period of time in addition to the current movements, the movements that were completed some time ago can also be reported to the detection unit. This is advantageous when returning from standby mode to active mode, as the detection unit is then also informed of movements of objects or accessories that had already been completed before the standby mode was ended and that may have caused the operating table or patient transporter to wake up.

In some embodiments, at least some of the objects and/or accessories may additionally include an accelerometer. When the object and/or accessory is attached to the patient positioning device, for example to a side rail, the accelerometer measures a shock, i.e., an acceleration. In addition, if an accelerometer is integrated into the patient positioning device or another component of the operating table, this accelerometer should also measure any vibration caused by the attachment of the object and/or accessory. Relevant information can be sent to the detection unit from the accelerometer of the object and/or accessory and the accelerometer of the patient positioning device or operating table. The detection unit can evaluate this information and determine that an object and/or accessory may have been attached to the patient positioning device if both accelerometers have detected corresponding accelerations, in particular simultaneously.

According to a second aspect of the present disclosure, a method is provided for detecting an object or accessory placed on a patient positioning device or attached to the patient positioning device or moved on the patient positioning device or removed from the patient positioning device. The patient positioning device may be a surgical patient positioning device that can be used as part of an operating table. A load sensor array having at least one load sensor that outputs sensor values may be provided. A load and/or a center of gravity of the load can be determined on the basis of the sensor values, the load including a load acting on the load sensor array or a load acting on the patient positioning device. If an object or accessory is placed on the patient support, attached to the patient support, moved on the patient support, or removed from the patient support and the determined load and/or center of gravity of the load changes as a result, the weight and/or center of gravity of the object or accessory can be determined therefrom.

The method according to the second aspect can have any and all configurations described in the present disclosure in connection with the system according to the first aspect.

The present disclosure also includes circuits and/or electronic instructions for controlling surgical tables, as well as remote controls, displays, and user interfaces for use with surgical tables.

### BRIEF DESCRIPTION OF THE DRAWINGS

Exemplary embodiments of the present disclosure will be explained in greater detail below with reference to the figures. In particular:

FIG. 1 shows a schematic side view of an operating table according to the disclosure with a patient positioned on a patient positioning device of the operating table;

FIG. 2 shows a schematic representation of the system architecture of a system according to the disclosure;

FIG. 3 shows a schematic representation of an operating table according to the disclosure illustrating the measuring load, the effective load, and the total load;

FIGS. 4A to 4C show schematic representations of various embodiments of an operating table according to the disclosure with a load sensor array in different positions;

FIGS. 5A to 5D show schematic representations of various embodiments of an operating table according to the disclosure with force sensors arranged in parallel and mirror-symmetrically;

FIGS. 6A and 6B show schematic representations illustrating the forces acting on the force sensors;

FIGS. 7A and 7B show schematic representations illustrating the reduction of transverse forces due to the symmetrical arrangement of the force sensors;

FIG. 8 shows a schematic representation illustrating the determination of the gravitational vector in the case of an inclined patient positioning device;

FIGS. 9A to 9F show schematic representations of a patient positioning device according to the disclosure with an object placed thereon and an accessory attached thereto;

FIG. 10 shows a schematic representation of a patient positioning device according to the disclosure with a division of the patient positioning device and its surroundings into different regions;

FIG. 11 shows a schematic representation of two operating rooms and a storage room, as well as objects and accessories that emit identification codes via radio;

FIG. 12 shows a schematic representation of an operating room with an operating table and objects and accessories that are not connected to or placed on the operating table; and

FIG. 13 shows a schematic representation of the operating room from FIG. 12 after an accessory has been attached to the operating table.

### DETAILED DESCRIPTION OF THE FIGURES

In the following description, exemplary embodiments of the present disclosure will be described with reference to the drawings. The drawings are not necessarily to scale, but are intended to illustrate the respective features only schematically.

It should be noted that the features and components described below can be combined with one another regardless of whether they have been described in connection with a single embodiment. The combination of features in the respective embodiments is merely illustrative of the basic construction and functionality of the claimed device.

In the figures, identical or similar elements are provided with identical reference symbols where appropriate.

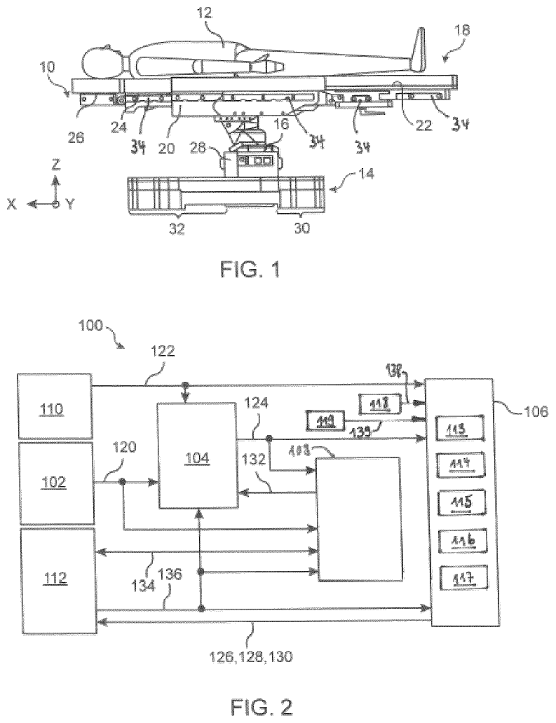

FIG. 1 shows a schematic view of a mobile operating table 10 which can be used to position a patient 12 during a surgical procedure and for transporting them. From bottom to top, the mobile operating table 10 comprises a base 14 for placing the operating table 10 on a surface, a vertically arranged operating table column 16 comprising the base 14, and a patient positioning device 18 fastened to an upper end of the operating table column 16. The patient positioning device 18 can be permanently connected to the operating table column 16 or, alternatively, detachably attached to the operating table column 16.

The patient positioning device 18 is modular and serves to position the patient 12. The patient positioning device 18 comprises a main positioning surface section 20 which is connected to the operating table column 16 and can be extended as desired by coupling various secondary positioning surface sections. The patient positioning device 18 can be embodied as a tabletop of a surgical table or of the operating table 10. In FIG. 1, a leg section 22, a shoulder section 24, and a head section 26 are coupled to the main positioning surface section 20 as secondary positioning surface sections.

The patient positioning device 18 of the operating table 10 can be adjusted to a suitable height and tilted or canted depending on the type of surgical procedure to be performed.

The operating table column 16 is height-adjustable and has an internal mechanism for adjusting the height of the patient positioning device 18 of the operating table 10. The mechanism is arranged in a housing 28, which protects the components from contamination.

The base 14 has two sections 30, 32 of different lengths. The section 30 is a short section which is associated with a foot end of the leg section 22, i.e., the end of the patient positioning device 18 on which the feet of the patient 12 to be treated lie. The section 32 is a long section associated with the head section 26 of the patient positioning device 18.

Furthermore, the base 14 can have wheels or rollers with which the operating table 10 can be moved on the floor. Alternatively, the base 14 can be permanently anchored to the ground.

Side rails 34 are attached to both sides of the patient positioning device 18. Accessories can be detachably attached to the side rails 34.

For better illustration, a Cartesian coordinate system XYZ is shown in FIG. 1. The X-axis and Y-axis are the horizontal axes; the Z-axis is the vertical axis. The X-axis extends along the adjacent positioning surface sections 22, 24, 26.

FIG. 2 shows a schematic of system architecture of a system 100 according to the disclosure. The system 100 is a system according to the first aspect of the present disclosure and can be operated by employing a method according to the second aspect.

In addition to an operating table 10 as shown in FIG. 1, the system 100 has a load sensor array 102, a load determination unit 104, a safety unit 106, a monitoring and calibration unit 108, a data storage 110, and other components 112 of the operating table system 100. Furthermore, the safety unit 106 contains a tipping prevention unit 113, an overload protection unit 114, a detection unit 115, a storage unit 116, and a storage unit 117. The storage units 116 and 117 can also be embodied as a common storage unit. In addition, the system 100 includes a reading unit 118 and a touch and/or motion sensor array 119.

The load sensor array 102 contains one or more load sensors and is designed to measure at least one quantity from which a load acting on the load sensor array 102 can be determined. In this case, the load sensors are force sensors, each of which measures a force acting on the respective sensor. The sensor or force values measured by the individual force sensors are outputted by the load sensor array 102 as a signal 120 in digital form. Furthermore, the load sensor array 102 contains electronic components that are required to operate the force sensors.

The load determination unit 104 receives the signal 120 with the measured sensor and/or force values and determines therefrom a load and/or a center of gravity of the load. The load determination unit 104 can determine a measuring load, an effective load, and/or a total load as the load.

In order to be able to adequately process and analyze the supplied force values, the load determination unit 104 requires some data on the geometry and the masses or weights of the operating table 10 and the accessories. These data are stored in the data memory 110 and are made available to the load determination unit 104 by means of a signal 122. In particular, information on the masses and centers of gravity of the individual components of the operating table 10 and the accessories can be obtained from these data. The data storage 110 can be expanded via a connectivity module of the operating table 10.

The load determination unit 104 generates a signal 124 as an output signal which contains information about the determined loads and/or centers of gravity of the loads. This information is transmitted to both the safety unit 106 and the monitoring and calibration unit 108.

In the safety unit 106, all available data is analyzed, including the loads, centers of gravity, and the position data of the operating table 10 and the accessories detected by the operating table 10. The safety unit 106 decides whether the operating table 10 is safe or whether it is in a hazardous situation. The safety unit 106 generates a safety signal 126 which indicates whether the operating table 10 is in a safety-critical state.

The algorithm reacts appropriately depending on the severity of the detected situation. For example, the operating table 10 can only issue a warning or stop the movement. The warnings can be issued via an acoustic or optical signal through the operating table 10 or in the form of text via the remote control. The measures may vary from slowing down the speed of movement to stopping the movement to blocking some functionalities and may continue until a state is reached in which the operating table 10 is safe again.

A provision can be made that the safety functions can be deactivated by the user at any time, enabling the movement of the operating table 10 to be continued at the user's own risk.

The tipping prevention unit 113 and the overload protection unit 114 are subunits of the safety unit 106. The tipping prevention unit 113 generates a tipping safety signal 128 based on the total load and/or the center of gravity of the total load, which indicates whether there is a risk that the operating table 10 will tip over. The overload protection unit 114 generates an overload protection signal 130 based on the active load and/or the center of gravity of the active load, which indicates whether there is an overload risk for the operating table 10 and/or at least one component of the operating table 10. Alternatively, the overload protection unit 114 may use the measuring load or the total load and/or the center of gravity of one of these loads to generate the overload protection signal 130. Both the tipping safety signal 128 and the overload protection signal 130 are safety signals of the safety unit 106.

If the base 14 does not have wheels or casters and is instead permanently attached to the floor, the tipping prevention unit 113 can be deactivated or not implemented in the safety unit 106.

The detection unit 115 receives the loads and/or centers of gravity of the loads determined by the load determination unit 104. When an object or accessory is placed on the patient positioning device 18 or attached to the patient positioning device 18 or moved on the patient positioning device 18 or removed from the patient positioning device 18, the load and/or the center of gravity of the load determined by the load determination unit 104 changes. Based on this change, the detection unit 115 can determine the weight and/or center of gravity of the object or accessory.

Adding or removing an object or accessory from the patient positioning device 18 changes the configuration of the patient positioning device 18. The load limits of the operating table 10 can be adjusted if the configuration changes. The tipping prevention unit 113 and the overload protection unit 114 can incorporate the changed configuration into the assessment of the tipping risk or the overload risk.

Since the system 100 is intended to reliably detect critical situations, the system 100 also has a monitoring and calibration unit 108. This software module checks the plausibility of the measured values and detects whether the system is malfunctioning or whether calibration or taring of the system 100 is required. The monitoring and calibration unit 108 generates corresponding output signals 132, 134 which are transmitted to the load determination unit 104 or the components 112 of the operating table 10.

The components 112 of the operating table 10 continuously generate position data, data for adjusting individual components, and information on the accessories recognized by the operating table 10. This data is made available to the system 100 with a signal 136.

The reading unit 118 and the touch and/or motion sensor array 119 are integrated into the operating table 10. The reading unit 118 can receive radio signals, in particular those emitted by proximity tags attached to objects or accessories. The reading unit 118 can make the received data 118 available to the detection unit 115 by means of a signal 138.

The touch and/or motion sensor array 119 can detect whether the patient positioning device 18 is touched or moved. If contact with or movement of the patient positioning device 18 is detected, the touch and/or motion sensor array 119 can transmit a signal 139 to the detection unit 115.

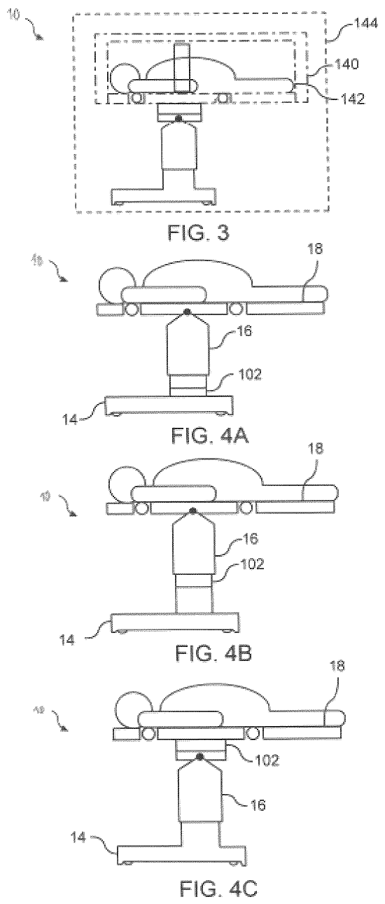

FIG. 3 schematically illustrates the different loads that the load determination unit 104 is able to determine based on the data provided by the load sensor unit 102. In FIG. 3, the measuring load, the effective load, and the total load are identified by reference numerals 140, 142, and 144, respectively. For each of these loads, the load determination unit 104 can determine the position of the associated center of gravity of the load.

The measuring load is the load acting on the load sensor array 102. The measuring load corresponds to the load generated by all persons, objects, and forces on the operating table 10 above the load sensors. The measuring load corresponds to the load value measured by the load sensor array 102.

The effective load corresponds to the load exerted by components which are not associated with the patient positioning device 18 or the operating table 10 and exerted by persons and external forces and acts on the operating table or the patient positioning device 18. The influence of the components and identified accessories associated with the patient positioning device 18 is not taken into account in the effective load. Only the remaining components of the patient positioning device 18 contribute to the effective load, i.e., the components not associated with the patient positioning device 18. These may, for example, be accessories that are not recognized by the operating table 10. Furthermore, the patient located on the patient positioning device 18 contributes to the effective load. All forces acting externally on the patient positioning device 18 that are exerted on the patient positioning device 18 by persons and/or objects outside the operating table 10, for example, also contribute to the effective load. The effective load is basically the measuring load without the influence of the known objects such as table top parts, detected accessories, etc.

The total load is the load resulting from the measuring load and from a load exerted by components associated with the operating table 10 and located below the load sensor array 102. The total load therefore takes into account loads from components that are located below the load sensor array 102 and cannot be measured by the load sensor array 102 and therefore do not contribute to the measuring load. The total load is therefore the load resulting from the entire operating table 10, the patient, the components associated with the operating table 10, the components not associated with the operating table 10, and other external forces.

FIGS. 4A to 4C show the operating table 10 according to the disclosure schematically in various embodiments.

In the operating table 10, the load sensor array 102 with the plurality of load sensors is arranged between at least two parts of the operating table 10. In particular, the at least two parts may be substantially immobile relative to one another. In this embodiment, the at least two parts do not move substantially relative to one another, i.e., they remain substantially in the same position relative to one another when the operating table 10, in particular the patient positioning device 18, is adjusted during operation, e.g., during tilting and/or canting and/or extension of the patient positioning device 18. This applies both to the distance between the at least two parts and to the angle(s) that the at least two parts form with each other.

The load sensor array 102 is preferably integrated into the operating table 10 in such a way that the entire load above the load sensors flows or is transmitted through the load sensor array 102.

The load sensor array 102 can be arranged at different positions in the operating table 10. In the embodiment shown in FIG. 4A, the load sensor array 102 is arranged between the base 14 and the operating table column 16, whereas the load sensor array 102 in FIG. 4B is integrated into the operating table column 16. In FIG. 4C, the load sensor array 102 is located adjacent to the interface between the patient positioning device 18 and the operating table column 16.

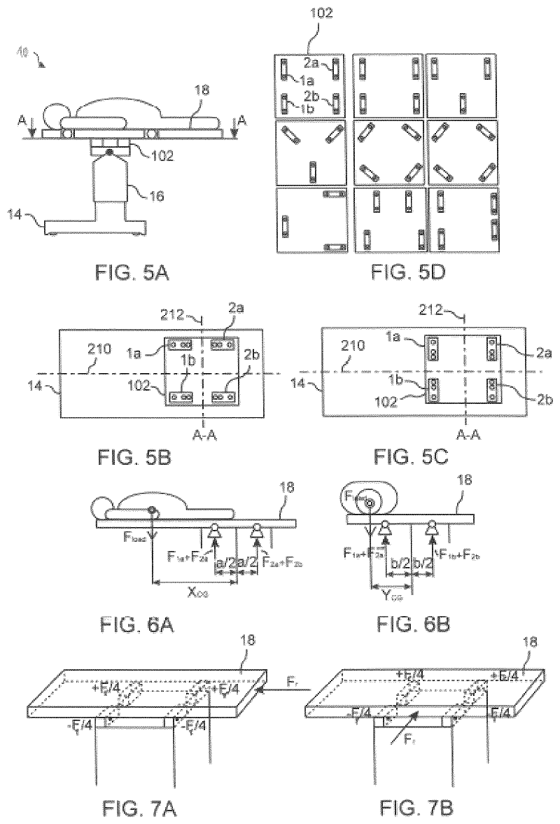

FIG. 5A shows the operating table 10 with a load sensor array 102 arranged between the patient positioning device 18 and the operating table column 16. The load sensor array 102 contains four identical force sensors 1a, 1b, 2a and 2b which are arranged in parallel and in mirror symmetry to one another. Two different variants for the placement of the force sensors 1a, 1b, 2a, 2b are illustrated in FIGS. 5B and 5C. FIGS. 5B and 5C each show a plan view of the load sensor array 102 along a line AA shown in FIG. 5A.

A first axis 210 and a second axis 212, which are perpendicular to each other, are specified for the purpose of aligning the force sensors 1a, 1b, 2a, 2c. The first axis 210 extends parallel to a main axis of the patient positioning device 18, while the second axis 212 extends perpendicular to this main axis but parallel to the patient positioning device 18.

The force sensors 1a, 1b, 2a, 2c each have a main axis which is aligned parallel to the first axis 210 in FIG. 5B. In FIG. 50, the main axes of the force sensors 1a, 1b, 2a, 2b are aligned parallel to the second axis 212. Furthermore, the force sensors 1a, 1b, 2a, 2b are arranged in pairs in mirror symmetry to the axes 210, 212. The pairs (1a, 1b), (1a, 2a), (1b, 2b), and (2a, 2b) each form a mirror-symmetric force sensor pair. In some embodiments, the force sensors 1a, 1b, 2a, 2b are arranged in a 2×2 grid as shown. In some embodiments, the grid arrangement has at least two force sensors 1a, 1b, 2a, 2b on each side. In some embodiments, the force sensors 1a, 1b, 2a, 2b all lie in a single common plane that is intersected by both the first axis 210 and the second axis 212.

The force sensors can also be arranged within the sensor array 102 differently than in FIGS. 5B and 5C. Several exemplary alternative arrangements of the force sensors in the sensor array 102 are shown in FIG. 5D.

Using the example of the sensor array 102 shown in FIG. 5B or 5C, the measured load can be calculated by adding all of the forces measured by the sensors 1a, 1b, 2a, 2b. The corresponding center of gravity can be calculated using the torque compensation equation shown below and the forces shown in FIGS. 6A and 6B. FIG. 6A shows a cross-sectional view along the x-axis, and FIG. 6B shows a cross-sectional view along the y-axis. The torque balance equation can be applied in both directions, enabling the x and y components of the center of gravity to be determined:

$$\text{?} \qquad 1$$

$${X}_{CG} = \frac{{F}_{1 a} + {F}_{1 b}}{{F}_{load}} a \frac{a}{2} \qquad 2$$

$${Y}_{CG} = \frac{{F}_{1 a} + {F}_{2 a}}{{F}_{load}} b - \frac{b}{2} \qquad 3$$

$$\text{?} \text{indicates text missing or illegible when filed}$$

In equations (1) to (3), F_{load} is the weight force generated by the patient. The forces F₁ₐ, F_{1b}, F₂ₐ, and F_{2b} are the forces measured by the sensors 1a, 1b, 2a, 2b. The parameters a and b are the distances of the sensors in the x and y directions, respectively. X_{CG} and Y_{CG} are the x- and y-coordinates, respectively, of the center of gravity of the load exerted by the patient.

The effective load and the total load as well as the corresponding center of gravity values thereof can be calculated by adding or subtracting the corresponding components of the operating table 10 and the center of gravity values thereof stored in the data memory 110.

The arrangement of the sensors 1a, 1b, 2a, 2b proposed in FIGS. 5B and 5C makes the system robust against transverse forces Fr. By virtue of the symmetrical arrangement, transverse forces Fr are canceled out as shown in FIGS. 7A and 7B.

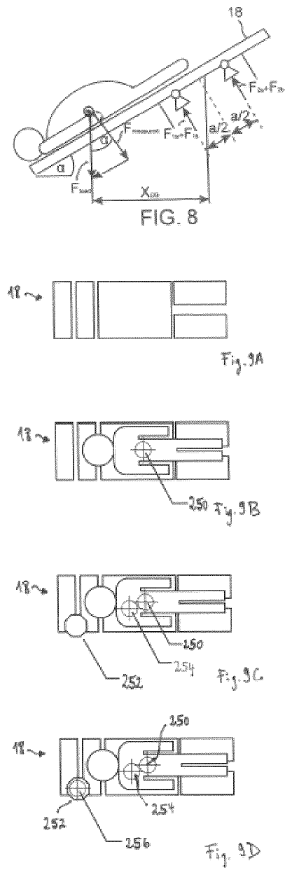

The cancellation of the transverse forces also enables the described system to reliably measure forces and center of gravity when the patient support device 18 is in an inclined position. FIG. 8 shows how the gravitational vector F_{load} can be split into two components. One component is located laterally to the force sensors and is canceled out due to the effects explained above. The second component F_{measured} extends perpendicular to the force sensors or to the main surface of the patient support device 18 and is reliably measured. If the angle of inclination a of the patient support device 18 is known, the actual load above the sensors and the center of gravity thereof can be calculated.

In the following, it will be explained how the detection unit 115 calculates the weight and center of gravity of an object or accessory that has been placed on or attached to the patient support device 18 or moved on or removed from the patient support device 18. First, the load determination unit 104 determines the load acting on the patient support device 18 and the center of gravity thereof using equations (1) to (3). These data are stored for some length of time, for example for a time period tₚ. The object or accessory is then placed on or attached to the patient support device 18 or moved thereon or removed from the patient support device 18. Thereafter, the load determination unit 104 again determines the load acting on the patient support device 18 and the center of gravity thereof at time t.

The detection unit 115 can calculate the weight and the x and y coordinates of the center of gravity of the object or accessory using the following equations (4) to (6):

$${m}_{added / removed} = {m}_{t} - {m}_{t - {t}_{p}} \qquad ( 4 )$$

$${X}_{added / removed} = \frac{{X}_{t} \times {m}_{t} - {X}_{t - {t}_{p}} \times {m}_{t - {t}_{p}}}{{m}_{added / removed}} \qquad ( 5 )$$

$$\text{?} \qquad 6$$

$$\text{?} \text{indicates text missing or illegible when filed}$$

The following variables are employed in equations (4) to (6):
m_{added/removed}: weight of the object or accessory added or removed
X_{added/removed}: X-coordinate of the center of gravity of the added or removed object or accessory
Y_{added/removed}: y-coordinate of the center of gravity of the added or removed object or accessory
mₜ: total weight acting on the patient positioning surface 18 after the addition or removal of the object or accessory
Xₜ: x-coordinate of the center of gravity of the total weight acting on the patient positioning surface 18 after the addition or removal of the object or accessory
Yₜ: y-coordinate of the center of gravity of the total weight acting on the patient positioning surface 18 after the addition or removal of the object or accessory
mₜ₋ₜ_{ₚ}: total weight acting on the patient positioning surface 18 before the addition or removal of the object or accessory
Xₜ₋ₜ_{ₚ}: X-coordinate of the center of gravity of the total weight acting on the patient positioning surface 18 before the addition or removal of the object or accessory
Yₜ₋ₜ_{ₚ}: y-coordinate of the center of gravity of the total weight acting on the patient positioning surface 18 before the addition or removal of the object or accessory

If the weight calculated by the detection unit 115m_{added/removed} is positive, an object or accessory has been placed on or attached to the patient positioning device 18. If it is negative, it means that an object or accessory has been removed from the patient positioning device 18.

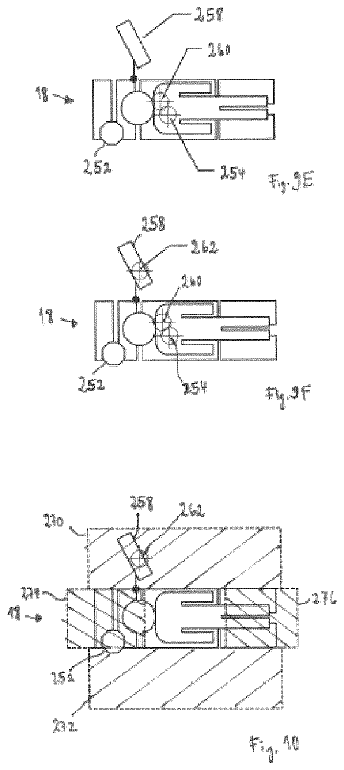

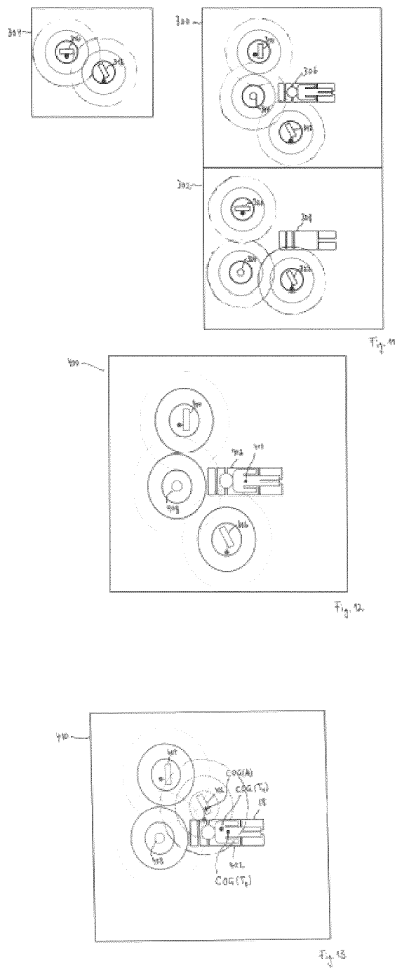

FIGS. 9A to 9F show the patient positioning device 18 schematically from above on which first a patient and then an object are placed and to which an accessory is also finally attached. The load sensor array 102 continuously measures the force acting on the force sensors, and the load determination unit 104 determines from the force values the load acting on the patient positioning device 18 and the center of gravity of the load. The detection unit 115 continuously monitors the current load acting on the patient positioning device 18 for significant changes and tracks the values for load and for center of gravity before and after the load changes. The detection unit 115 can observe when items are added to or removed from the patient positioning device 18 and can also determine the weight of those items and the location at which they were added or removed.

FIG. 9A shows the patient positioning device 18, on which no external forces are acting.

In FIG. 9B, a patient has been placed on the patient positioning device 18. The load determination unit 104 determines the load acting on the patient positioning device 18 that is being exerted by the patient and the center of gravity 250 thereof.

In FIG. 9C, an object 252 is being placed at the head end of the patient positioning device 18. This changes both the load acting on the patient positioning device 18 and the center of gravity thereof. The load determination unit 104 determines the new load exerted by the patient and the object 252 and the center of gravity thereof 254, which has shifted from the previous center of gravity 250.

The detection unit 115 compares the loads acting on the patient positioning device 18 before and after placement of the object 252 and the centers of gravity thereof. These comparisons enable the patient positioning device 18 to determine both the weight of the object 252 and the center of gravity 256 of the object 252 after it has been placed on the patient positioning device 18.

In FIG. 9E, an accessory 258 is attached to a side rail of the patient positioning device 18. The load on the patient positioning device 18 changes accordingly, and the center of gravity of the load shifts from the previous position 254 to the current center of gravity 260 of the load.

By comparing the centers of gravity 254 and 260 of the loads, i.e., the centers of gravity of the loads before and after the attachment of the accessory 258 to the patient positioning device 18, and by comparing the associated loads, the detection unit 115 determines both the weight of the accessory 258 and the center of gravity 262 thereof. The center of gravity 262 of the accessory 258 is shown in FIG. 9F.

The storage unit 116 of the system 100 shown in FIG. 2 stores weight information for various predefined accessories. Table 1 below shows an example of such a database.

TABLE 1

| Accessory | Weight |
|---|---|
| Accessory A | 5.3 kg |
| Accessory B | 7.0 kg |
| Accessory C | 3.5 kg |
| Accessory D | 5.3 kg |

The detection unit 115 has access to the storage unit 116 and compares the weight of the accessory 258 determined by it with the weight information stored in the storage unit 116. This makes it possible for a list of accessories that may have been added to the patient positioning device 18 to be created.

Assuming that the weight of the accessory 258 added to the side rail is 5.3 kg, Table 1 shows that accessories A and D also weigh 5.3 kg. The accessory 258 could therefore possibly be accessory A or D. In addition, accessories B and C can be excluded as possible candidates for the accessory 258 due to their weight. However, it cannot be ruled out that the accessory 258 is an object that is not known to the database. In that case, the similarly measured weight would be just a coincidence.

In some cases, the location at which the accessory is attached can also provide information about what item has been attached. For example, a properly used side rail accessory is unlikely to have its center of gravity in the center of the patient support assembly 18, and an accessory that is designed for use with the patient's legs will be more likely to be mounted at the foot end of the operating table.

FIG. 10 shows the patient positioning device 18, on which the object 252 has been placed as in FIG. 9F, the accessory part 258 being additionally attached to a side rail. FIG. 10 also shows the center of gravity 262 of the accessory 258 calculated by the detection unit 115. Furthermore, the immediate surroundings of the patient positioning device 18 and a part of the patient positioning device 18 are virtually divided into regions 270, 272, 274, 276. The regions 270 and 272 are arranged laterally of the patient positioning device, while the regions 274 and 276 are arranged in the head and foot regions, respectively.

Region information is stored in the memory unit 117 of the system 100 shown in FIG. 2 which indicates in which of the regions 270, 272, 274, 276 predetermined accessories are usually arranged. For example, accessories that are attached to the side rails are typically found in the side regions 270, 272. The detection unit 115 has access to the storage unit 117. Since the detection unit 115 knows the center of gravity 262 of the accessory 258, the detection unit 115 knows that the accessory 258 is located in the region 270. The detection unit 115 can extract from the storage unit 117 possible candidates that are arranged in the region 270 and that might possibly be the accessory part 258. Together with the data about the weight of the accessory 258 stored in the storage unit 116, it may be possible to reduce the possible candidates for the accessory 258 to only very few accessories or even just one accessory.

In some embodiments, proximity tags are attached to the accessories and also to some objects. The proximity tags emit a respective identification code that can be used to identify the respective accessory or object. The reading unit 118 shown in FIG. 2 can receive the radio signals emitted by the proximity tags and transmit the received identification codes to the detection unit 115. This enables the detection unit 115 to determine which accessories and objects are located in the vicinity of the patient positioning device 18 based on the identification codes received from the reading unit 118. Furthermore, this information can also be used for other applications.

FIG. 11 shows two adjacent operating rooms 300, 302 with a respective operating table 306 or 308 and a storage room 304. Accessories 310, 312 and an object 314 are located in the operating room 300. In addition, accessories 316, 318 are located in the storage room 304, and accessories 320, 322 and an object 324 are located in the operating room 302. All accessories and objects have respective proximity tags that emit radio signals.

The accessories 310, 312 and the object 314 are located near the operating table 306, meaning that the operating table 306 can receive their radio signals and identify them. Depending on the data transmission technology, it is possible for the operating table 308 to also detect the presence of the accessories 310, 312 and of the object 314. It is possible that the operating table 308 may determine from the signal strength that these items are too far away and therefore not being used with it. In preferred embodiments, the operating tables 306, 308 and/or the reading units 118 are thus capable of detecting proximity tags that are at a distance from the reading units 118. For example, proximity tags that are located at a distance of at least 0.5 m or at least 1 m or more from the reading units 118 can be detected.

If both operating tables 306, 308 were located in the same room, the operating tables 306, 308 or another system could compare the signal strengths measured by each of the operating tables 306, 308 in order to determine which operating table the respective accessory or object should be associated with.

A threshold value for the signal strength can also be specified. If the signal strength received by the reading unit 118 of the operating table 306 is greater than the threshold, the detection unit can determine that the corresponding accessory or object is located in the vicinity of the operating table 306.

The objects and accessories can also have a motion detector that checks whether the respective object or accessory is moving. The motion detector can transmit information about the motion state of the respective object or accessory to the proximity tag, which transmits this information to the reading unit 118 of the operating table 306. Furthermore, the motion detector can have a memory function which stores the movements of the respective object or accessory for a predetermined period of time. This information is also transmitted to the operating table 306.

In connection with FIGS. 9 and 10, an aspect of the present disclosure has been described according to which a change in the load acting on the patient positioning device 18 and the center of gravity thereof is observed and it can thus be detected when a new accessory or object is attached to or placed on the patient positioning device 18. In the same way, it can also be determined that an accessory or object has been removed from the patient positioning device 18, since this reduces the load acting on the patient positioning device 18, and the center of gravity of the load shifts accordingly. In addition, the weight of the accessory or object and the location at which the accessory or object was attached to or removed from the patient positioning device 18 can be calculated. In addition, databases can be used to create a list of known accessories and/or objects that could plausibly be the accessory or object being sought by matching the weights and/or mounting regions in the databases with the weight and/or center of gravity of the object.

In connection with FIG. 11, another aspect of the present disclosure was described in which proximity tags transmit radio signals with identification codes that can be received by a reader unit 118 associated with the operating table. This enables the operating table to detect accessories and objects that are in its vicinity and could therefore plausibly be attached to or have been placed on the operating table, or moved on or removed therefrom. It can also be examined whether any of the accessories and objects are moving or have recently been moving.

The two abovementioned aspects of the present disclosure may also be combined to further improve the detection and identification of the accessories and objects being sought. Some examples will be described in the following.

FIG. 12 shows an operating room 400 with an operating table 402 as well as accessories 404, 406 and an object 408. The load determination unit 104 of the operating table 402 determines the current weight and center of gravity 410 for the entire load currently on the operating table 402. In addition, the operating table 402 detects the accessories 404, 406 and the object 408 that are in its vicinity through the radio signals emitted by the proximity tags.

FIG. 13 shows the operating room 400 from FIG. 12, but in the meantime the accessory part 406 has been attached to a side rail of the operating table 402. The detection unit 115 carries out the following steps:
The detection unit 115 detects that the accessory 406 is moving or has recently moved because the motion detector of the accessory 406 detected the movement and the proximity tag reported this information to the operating table 402.
The detection unit 115 also detects that the load on the patient positioning device 18 and the center of gravity thereof have changed. The detection unit uses the load T₀ and the center of gravity COG(T₀) thereof determined before the load change and the load T₁ and the center of gravity COG(T₁) thereof determined after the load change to determine that a new object or accessory has been added to the patient positioning device 18. The detection unit 115 also uses this information to determine the weight of the new object or accessory and the center of gravity position COG(A) at which the object or accessory was attached to the patient positioning device 18.
By comparing the measured weight with the weight information stored in the storage unit 116, the detection unit 115 can also identify the accessory attached to the patient positioning device 18 as the accessory 406 because the weight of the new accessory matches the expected weight of accessory 406.

In this way, the detection unit 115 can continue to monitor any added and removed objects while the operating table 402 is being configured for its next use. There should be enough time between the addition or removal of objects or accessories to enable the detection unit 115 to distinguish between the individual objects and accessories.

The operating table 402 also includes the touch and/or motion sensor array 119 shown in FIG. 2, which can detect interactions with the operating table 402 even when the operating table 402 is in a standby mode. When an interaction is detected, the touch and/or motion sensor array 119 can awaken at least those devices which are required to perform the activities described herein. The detection unit 115 can store the current weight and center of gravity of the load on the patient positioning device 18 before transitioning to standby mode and immediately compare it with the new weight and center of gravity of the load on the patient positioning device 18 when the operating table 402 wakes up again and returns to active mode. Once an object is placed on the operating table 402, the operating table 402 can thus wake up, detect the change, and perform the activities described above.

The memory function of the motion detectors attached to the objects and/or accessories also makes it possible to report to the operating table 402 not only ongoing movements but also movements that were already completed some time ago. This is useful when waking up the operating table 402, since the operating table 402 is then also informed of information about movements of objects or accessories that had already been completed before the operating table 402 returned to the active mode and that may have caused the operating table 402 to wake up.

Exemplary embodiments and variations consistent with the present disclosure are described in the following list of points and options:
Point 1: A system (100) for detecting an object or accessory placed on a patient positioning device (18) or attached to the patient positioning device (18) or moved on the patient positioning device (18) or removed from the patient positioning device (18), the system (100) comprising:
   a surgical patient positioning device (18) which can be used as part of an operating table (10);
   a load sensor array (102) with at least one load sensor (1a, 1b, 2a, 2b) which outputs sensor values;
   a load determination unit (104) which determines a load and/or a center of gravity of the load based on the sensor values, the load including a load acting on the load sensor array (102) or a load acting on the patient positioning device (18); and
   a detection unit (115) which receives the load and/or the center of gravity of the load determined by the load determination unit (104) and which, when an object or accessory is placed on the patient positioning device (18) or fastened to the patient positioning device (18) or moved on the patient positioning device (18) or removed from the patient positioning device (18) and the load and/or the center of gravity of the load determined by the load determination unit (104) changes as a result, determines the weight and/or the center of gravity of the object or accessory therefrom.
Point 2: The system (100) according to point 1, wherein
   the load determination unit (104) is designed such that the load determination unit (104) determines the load and/or the center of gravity of the load before an object or accessory is placed on or attached to the patient positioning device (18) or moved on or removed therefrom, and the load determination unit (104) determines the load and/or the center of gravity of the load again after the object or accessory has been placed on or attached to the patient positioning device (18) or moved on or removed therefrom; and
   the detection unit (115) is designed such that the detection unit (115) determines the weight and/or the center of gravity of the object or accessory by the detection unit (115) comparing the loads and/or the centers of gravity of the loads determined before and after the object or accessory was placed on or attached to the patient positioning device (18) or moved on or removed therefrom.
Point 3: The system (100) according to point 1 or 2, wherein
   the system (100) has a first storage unit (116) in which weight information for predetermined objects and/or accessories is stored; and
   the detection unit (115) compares the weight of the object or accessory determined by it with the weight information and uses the comparison to determine which at least one object or accessory may have been placed on or attached to the patient positioning device (18) or moved on or removed therefrom.
Point 4: The system drive (100) according to any one of preceding claims, wherein
   at least a part of the patient positioning device (18) and in particular at least a part of the surroundings of the patient positioning device (18) is virtually divided into multiple regions, in particular into a minimum of at least one side region, one foot region, and one head region, and region information is stored in a second storage unit (117) which indicates in which regions predetermined objects and/or accessories are arranged; and
   the detection unit (115) compares the center of gravity of the object or accessory determined by it with the region information and uses the comparison to determine which at least one object or accessory may have been placed on or attached to the patient positioning device (18) or moved on or removed therefrom.
Point 5: The system (100) according to point 1, wherein
   the system (100) has a first storage unit (116) in which weight information for predetermined objects and/or accessories is stored; the load determination unit (102) is designed such that the load determination unit (102) determines the load before an object or accessory is placed on or attached to the patient positioning device (18) or moved on or removed therefrom, and the load determination unit (102) determines the load again after the object or accessory has been placed on or attached to the patient positioning device (18) or moved on or removed therefrom;
   the detection unit (115) is designed such that the detection unit (115) determines the weight of the object or accessory in that the detection unit (115) compares the loads determined before and after the object or accessory was placed on the patient positioning device (18) or attached to it or moved on it or removed therefrom, and, in particular, in that the detection unit (115) compares the centers of gravity of the loads determined by the load determination unit (104) before and after the object or accessory was placed on the patient positioning device (18) or attached to it or moved on it or removed therefrom; and
   the detection unit (115) compares the weight of the object or accessory determined by it with the weight information stored in the first storage unit (116) and uses the comparison to determine which at least one object or accessory may have been placed on the patient positioning device (18) or attached thereto or removed therefrom.
Point 6: The system drive (100) according to any one of preceding claims, wherein
   the load determination unit (104) is designed such that the load determination unit (104) determines the center of gravity of the load before an object or accessory is placed on or attached to the patient positioning device (18) or moved thereon or removed therefrom, and the load determination unit (104) determines the center of gravity of the load again after the object or accessory has been placed on or attached to the patient positioning device (18) or moved thereon or removed therefrom; and
   the detection unit (115) is designed such that the detection unit (115) determines the position of the object or accessory by comparing the centers of gravity of the loads determined before and after the object or accessory was placed on or attached to the patient positioning device (18) or moved on or removed therefrom.
Point 7: The system drive (100) according to any one of preceding claims, wherein
   at least some of the objects and/or accessories each have a proximity tag that emits a respective identification code;
   the system (100) comprises a reading unit (118) which receives the identification codes emitted by the proximity tags; and
   the detection unit (115) determines which objects or accessories are located in the vicinity of the patient positioning device (18) based on the identification codes received from the reading unit.
Point 8: The system (100) according to point 7, wherein the detection unit (115) determines whether the corresponding object or accessory is located in the vicinity of the patient positioning device (18) based on a signal strength with which the reading unit (118) receives an identification code.
Point 9: The system (100) according to point 8, wherein a threshold value for the signal strength is predetermined and the detection unit (115) determines that the corresponding object or accessory is located in the vicinity of the patient positioning device (18) if the signal strength received by the reading unit (118) exceeds the threshold value.
Point 10: The system (100) according to any one of points 7 to 9, wherein the transmission of the identification codes from the proximity tags to the reading unit (118) is based on the Bluetooth standard.
Point 11: The system (100) according to any one of points 7 to 10, wherein the detection unit (115) determines that an object or accessory has been placed on or attached to the patient positioning device (18) or moved on or removed therefrom if the detection unit (115) determines that the corresponding object or accessory is located in the vicinity of the patient positioning device (18) and the detection unit (115) further determines that the weight of the corresponding object or accessory determined by it lies within a predetermined range around the weight information for this object or accessory stored in the first storage unit (116) and/or that the center of gravity of the corresponding object or accessory determined by it lies within a range provided for this object or accessory and stored in the second storage unit (117).
Point 12: The system (100) according to any one of points 7 to 11, wherein the reading unit (118) is capable of identifying proximity tags, objects, and/or accessories that are not in the immediate vicinity of the reading unit (118), reading unit (118) being particularly capable of identifying proximity tags, objects, and/or accessories that are located at a distance of at least 0.5 meters or at least one meter from the reading unit (118).
Point 13: The system (100) according to any one of the preceding points, wherein at least some of the objects and/or accessories each have a motion detector which detects a movement of the respective object or accessory, and wherein information about the movement state of the object or accessory is transmitted to the detection unit (118).
Point 14: System according to point 13, wherein the motion detector and/or the detection unit (115) have a memory function which stores the movements of the respective object or accessory for a predetermined period of time.
Point 15: The system (100) according to point 13 or 14, wherein the detection unit (115) determines that an object or accessory has been placed on or attached to the patient positioning device (18) or moved on or removed therefrom if the detection unit (115) receives from the reading unit the identification code of the corresponding object or accessory and, additionally, the information that the corresponding object or accessory has moved or has recently moved, and the load determination unit (102) also determines that the load and/or the center of gravity of the load have changed.
Point 16: The system (100) according to any one of points 7 to 15, wherein the detection unit (115) determines that an object or accessory has been placed on or attached to the patient positioning device (18) or moved on or removed therefrom if the detection unit (115) determines that the weight of the corresponding object or accessory determined by it is within a predetermined range around the weight information for this object or accessory stored in the first storage unit (116).
Point 17: The system (100) according to any one of points 7 to 16, wherein the detection unit (115) determines that the corresponding object or accessory has been placed on or attached to the patient positioning device (18) or moved on or removed from the patient positioning device (18) if the detection unit (115) determines that the center of gravity of the corresponding object or accessory determined by it lies within a range provided for this object or accessory and stored in the second storage unit (117).
Point 18: The system drive (100) according to any one of preceding claims, wherein
   at least a part of the system (100) can be operated in an active mode or standby mode;
   the load and/or the center of gravity of the load determined by the load determination unit (102) are stored before switching to the standby mode;
   the load determination unit (102) determines the load and/or the center of gravity of the load immediately after returning to the active mode;
   the detection unit (115) compares the load and/or the center of gravity of the load before switching to the standby mode with the load and/or the center of gravity of the load after returning to the active mode; and
   the detection unit (115) uses the comparison or comparisons to determine whether an object or accessory has been placed on or attached to the patient positioning device (18) or moved on or removed therefrom while the at least part of the system (100) was operating in standby mode.
Point 19: The system (100) according to point 18, wherein the system (100) comprises a touch and/or motion sensor array (119) which is configured to detect a contact with and/or movement of the patient positioning device (18) and to cause the patient positioning device (18) to return to the active mode if a contact and/or movement of the patient positioning device (18) is detected during the standby mode.
Point 20: The system (100) according to any one of the preceding points, wherein at least some of the objects and/or accessories each have a first accelerometer and the patient positioning device (18) or the operating table (10) has a second accelerometer, and the detection unit determines that an object and/or accessory may have been placed on or attached to the patient positioning device (18) or moved on or removed therefrom if the first and second accelerometers simultaneously sense accelerations.
Point 21: The system (100) according to any one of the preceding points, wherein the object or accessory can be detachably connected to a side rail (34) of the patient positioning device (18).
Point 22: The system (100) according to any one of the preceding points, wherein the patient positioning device (18) is connected to a column (16) of an operating table (10) and/or can be detachably connected to a column of an operating table and a surgical patient transporter.
Point 23: The system (100) according to point 22, wherein the load sensor array (102) is integrated into the patient transporter.
Point 24: The system (100) according to any one of the preceding points, wherein the accessory can be an accessory from the following group of accessories or a differently designed accessory: an anesthesia hanger for receiving surgical drapes, a tube holder for securing a ventilation tube, a side protection wall for securing the patient during transport on the patient positioning device, an infusion holder, a flushing set for collecting and draining liquids, a catheter tray for storing catheters during surgery, an instrument table for storing instruments during surgery, a tray for dirty instruments, a disposal tray for receiving surgical waste, and a push handle for moving operating tables.
Point 25: The system (100) according to any one of the preceding points, wherein the object can be an object from the following group of objects or a differently configured object: a urine collection bag, a scale for a urine collection bag, an infusion solution, a saline solution, an infusion pump, a surgical drape, an auxiliary device, a lung assist device, an instrument, an X-ray image cassette, and a radiation shielding curtain.
Point 26: The system (100), comprising a surgical patient positioning device (18) which can be used as part of an operating table (10), and a touch and/or motion sensor array (119) which is configured to detect a contact with and/or movement of the patient positioning device (18) and which causes the patient positioning device (18) to return to an active mode if a contact with and/or movement of the patient positioning device (18) is detected during a standby mode.
Point 27: A method for detecting an object or accessory placed on a patient positioning device (18) or attached to the patient positioning device (18) or moved on the patient positioning device (18) or removed from the patient positioning device (18), wherein:
   the patient positioning device (18) is a surgical patient positioning device (18) that can be used as part of an operating table (10);
   a load sensor array (102) with at least one load sensor (1a, 1b, 2a, 2b) which outputs sensor values is provided;
   a load and/or a center of gravity of the load is determined based on the sensor values, the load including a load acting on the load sensor array (102) or a load acting on the patient positioning device (18); and
   when an object or accessory is placed on the patient positioning device (18) or fastened to the patient positioning device (18) or moved on the patient positioning device (18) or removed from the patient positioning device (18) and the determined load and/or the center of gravity of the load changes as a result, the weight and/or the center of gravity of the object or accessory is determined therefrom.

1. A system for detecting an object or accessory placed on a patient positioning device or attached to the patient positioning device or moved on the patient positioning device or removed from the patient positioning device, the system comprising:
a surgical patient positioning device which can be used as part of an operating table;
a load sensor array with at least one load sensor which outputs sensor values;
a load determination unit which determines a load and/or a center of gravity of the load based on the sensor values, the load including a load acting on the load sensor array or a load acting on the patient positioning device; and
a detection unit which receives the load and/or the center of gravity of the load determined by the load determination unit, characterized in that, when an object or accessory is placed on the patient positioning device or fastened to the patient positioning device or moved on the patient positioning device or removed from the patient positioning device and the load and/or the center of gravity of the load determined by the load determination unit changes as a result, the detection unit determines from the change in the load and/or of the center of gravity of the load the weight and/or the center of gravity of the object or accessory.

2. The system according to claim 1, wherein
the load determination unit is designed such that the load determination unit determines the load and/or the center of gravity of the load before an object or accessory is placed on or attached to the patient positioning device or moved on or removed therefrom, and the load determination unit determines the load and/or the center of gravity of the load again after the object or accessory has been placed on or attached to the patient positioning device or moved on or removed therefrom; and
the detection unit is designed such that the detection unit determines the weight and/or the center of gravity of the object or accessory by the detection unit comparing the loads and/or the centers of gravity of the loads determined before and after the object or accessory was placed on or attached to the patient positioning device or moved on or removed therefrom.

3. The system according to claim 1, wherein
the system has a first storage unit in which weight information for predetermined objects and/or accessories is stored; and
the detection unit compares the weight of the object or accessory determined by it with the weight information and uses the comparison to determine which at least one object or accessory may have been placed on or attached to the patient positioning device or moved on or removed therefrom.

4. The system according to claim 1, wherein
at least a part of the patient positioning device and in particular at least a part of the surroundings of the patient positioning device is virtually divided into multiple regions, in particular into a minimum of at least one side region, one foot region, and one head region, and region information is stored in a second storage unit which indicates in which regions predetermined objects and/or accessories are arranged; and
the detection unit compares the center of gravity of the object or accessory determined by it with the region information and uses the comparison to determine which at least one object or accessory may have been placed on or attached to the patient positioning device or moved on or removed therefrom.

5. The system according to claim 1, wherein
the system has a first storage unit in which weight information for predetermined objects and/or accessories is stored;
the load determination unit is designed such that the load determination unit determines the load before an object or accessory is placed on or attached to the patient positioning device or moved on or removed therefrom, and the load determination unit determines the load again after the object or accessory has been placed on or attached to the patient positioning device or moved on or removed therefrom;
the detection unit is designed such that the detection unit determines the weight of the object or accessory in that the detection unit compares the loads determined before and after the object or accessory was placed on the patient positioning device or attached to it or moved on it or removed therefrom, and, in particular, in that the detection unit compares the centers of gravity of the loads determined by the load determination unit before and after the object or accessory was placed on the patient positioning device or attached to it or moved on it or removed therefrom; and
the detection unit compares the weight of the object or accessory determined by it with the weight information stored in the first storage unit and uses the comparison to determine which at least one object or accessory may have been placed on the patient positioning device or attached thereto or moved thereon or removed therefrom.

6. The system according to claim 1, wherein
the load determination unit is designed such that the load determination unit determines the center of gravity of the load before an object or accessory is placed on or attached to the patient positioning device or moved thereon or removed therefrom, and the load determination unit determines the center of gravity of the load again after the object or accessory has been placed on or attached to the patient positioning device or moved thereon or removed therefrom; and
the detection unit is designed such that the detection unit determines the position of the object or accessory by comparing the centers of gravity of the loads determined before and after the object or accessory was placed on or attached to the patient positioning device or moved on or removed therefrom.

7. The system according to claim 1, wherein
at least some of the objects and/or accessories each have a proximity tag that emits a respective identification code;
the system comprises a reading unit which receives the identification codes emitted by the proximity tags; and
the detection unit determines which objects or accessories are located in the vicinity of the patient positioning device based on the identification codes received from the reading unit, particularly if the identification code is received from a proximity tag that is at a distance from the reading unit.

8. The system according to claim 7, wherein the detection unit determines whether the corresponding object or accessory is located in the vicinity of the patient positioning device based on a signal strength with which the reading unit receives an identification code.

9. The system according to claim 8, wherein a threshold value for the signal strength is predetermined and the detection unit determines that the corresponding object or accessory is located in the vicinity of the patient positioning device if the signal strength received by the reading unit exceeds the threshold value.

10. The system according to claim 7, wherein the transmission of the identification codes from the proximity tags to the reading unit is based on the Bluetooth standard.

11. The system according to claim 7, wherein the detection unit determines that an object or accessory has been placed on or attached to the patient positioning device or moved on or removed therefrom if the detection unit determines that the corresponding object or accessory is located in the vicinity of the patient positioning device and the detection unit further determines that the weight of the corresponding object or accessory determined by it lies within a predetermined range around the weight information for this object or accessory stored in the first storage unit and/or that the center of gravity of the corresponding object or accessory determined by it lies within a range provided for this object or accessory and stored in the second storage unit.

12. The system according to claim 1, wherein at least some of the objects and/or accessories each have a motion detector which detects a movement of the respective object or accessory, and wherein information about the movement state of the object or accessory is transmitted to the detection unit.

13. The system according to claim 12, wherein the motion detector and/or the detection unit have a storage function which stores the movements of the respective object or accessory for a predetermined period of time.

14. The system according to claim 12, wherein the detection unit determines that an object or accessory has been placed on or attached to the patient positioning device or moved on or removed therefrom if the detection unit receives from the reading unit the identification code of the corresponding object or accessory and, additionally, the information that the corresponding object or accessory has moved or has recently moved, and the load determination unit also determines that the load and/or the center of gravity of the load have changed.

15. The system according to claim 7, wherein the detection unit determines that an object or accessory has been placed on or attached to the patient positioning device or moved on or removed therefrom if the detection unit determines that the weight of the corresponding object or accessory determined by it is within a predetermined range around the weight information for this object or accessory stored in the first storage unit.

16. The system according to claim 7, wherein the detection unit determines that the corresponding object or accessory has been placed on or attached to the patient positioning device or moved on or removed from the patient positioning device if the detection unit determines that the center of gravity of the corresponding object or accessory determined by it lies within a range provided for this object or accessory and stored in the second storage unit.

17. The system according to claim 1, wherein
at least a part of the system can be operated in an active mode or standby mode;
the load and/or the center of gravity of the load determined by the load determination unit are stored before switching to the standby mode;
the load determination unit determines the load and/or the center of gravity of the load immediately after returning to the active mode;
the detection unit compares the load and/or the center of gravity of the load before switching to the standby mode with the load and/or the center of gravity of the load after returning to the active mode; and
the detection unit uses the comparison or comparisons to determine whether an object or accessory has been placed on or attached to the patient positioning device or moved on or removed therefrom while the at least part of the system was operating in standby mode.

18. The system according to claim 17, wherein the system comprises a touch and/or motion sensor array which is configured to detect a contact with and/or movement of the patient positioning device and to cause the patient positioning device to return to the active mode if a contact and/or movement of the patient positioning device is detected during the standby mode.

19. The system according to claim 1, wherein the object or accessory can be detachably connected to a side rail of the patient positioning device.

20. The system according to claim 1, wherein the patient positioning device is connected to a column of an operating table and/or can be detachably connected to a column of an operating table and a surgical patient transporter.

21. The system according to claim 20, wherein the load sensor array is integrated into the patient transporter.

22. A method for detecting an object or accessory placed on a patient positioning device or attached to the patient positioning device or moved on the patient positioning device or removed from the patient positioning device, wherein:
the patient positioning device is a surgical patient positioning device that can be used as part of an operating table;
a load sensor array with at least one load sensor which outputs sensor values is provided;
a load and/or a center of gravity of the load is determined based on the sensor values, the load including a load acting on the load sensor array or a load acting on the patient positioning device; and characterized in that,
when an object or accessory is placed on the patient positioning device or fastened to the patient positioning device or moved on the patient positioning device or removed from the patient positioning device and the determined load and/or the center of gravity of the load changes as a result, the weight and/or the center of gravity of the object or accessory is determined from the change in the load and/or in the center of gravity of the load.
